(19) United States
(12) Patent Application Publication
(10) Pub. No.: US 2012/0300135 A1
(43) Pub. Date: Nov. 29, 2012

(54) LIGHTING DEVICE, DISPLAY DEVICE AND TELEVISION RECEIVER

(75) Inventor: Shiyoshi Cho, Osaka-shi (JP)

(73) Assignee: SHARP KABUSHIKI KAISHA, Osaka-shi, Osaka (JP)

(21) Appl. No.: 13/518,895

(22) PCT Filed: Dec. 1, 2010
(86) PCT No.: PCT/JP2010/071448

§ 371 Date: Jun. 25, 2012

(30) Foreign Application Priority Data
Jan. 4, 2010 (JP) 2010-000045

(51) Int. Cl. F21V 8/00; G02F 1/13357; H04N 5/66; F21V 7/00

(52) U.S. Cl. 348/739; 362/613; 362/609; 362/612; 349/62; 348/E05.133

(57) ABSTRACT

In a lighting device, it is controlled whether or not to exit light for every small area of a light guide member and good operability is obtained for installation of the light guide member. Uneven brightness is less likely to occur. A backlight unit 12 includes LEDs 17 as light sources, a light guide member 19 having a light entrance surface 19b which light from the LEDs 17 enters and a light exit surface 19a from which light exits, and a groove portion 22 formed on a surface of the guide member 19 opposite to the exit surface 19a so as to divide the exit surface 19a into areas A in a plan view. The LEDs 17 are arranged corresponding to each area A and the groove portion 22 includes an LED housing groove portion 22A housing at least one of the LEDs 17 therein and having an inner surface that is the entrance surface 19b.

### TECHNICAL FIELD

The present invention relates to a lighting device, a display device and a television receiver.

### BACKGROUND ART

In recent years, a type of an image display device including a television receiver has been shifted from a conventional CRT display device to a thin display device using a thin display element such as a liquid crystal panel and a plasma display and a thin image display device is made possible. A liquid crystal panel used for a liquid crystal display device does not emit light, and thus a backlight unit is required as a separate lighting device. A type of a backlight unit is broadly divided into a direct type and an edge-light type. To achieve a thinner liquid crystal display device, an edge-light type backlight unit is preferably used. An edge-light type backlight unit disclosed in Patent Document 1 has been known.

Patent Document 1: Japanese Unexamined Patent Publication No. 2001-92370

### Problem to be Solved by the Invention

The edge-light type backlight unit disclosed in Patent Document 1 includes a plurality of light sources that is arranged linearly at the edge of the backlight unit and light guide plates that guide light from the light sources and direct the light toward a liquid crystal panel. Each of the light guide plates extends in a direction that is perpendicular to the arrangement direction of the light sources. The light guide plates are arranged in the arrangement direction of the light sources.

Each light guide plate extends in the direction that is perpendicular to the arrangement direction of the light sources. This may cause a following problem. Partial light exit control cannot be executed in the direction that is perpendicular to the arrangement direction of the light sources. Furthermore, Patent Document 1 discloses a technique of using a plurality of divided pieces of light guide plates, and accordingly, operations for installing a plurality of light guide plates into a chassis are complicated. This causes poor operability. If using a plurality of the light guide plates, positional displacement is likely to occur in each light guide plate in installing each light guide plate in the chassis. Positional relationships between each light source and each light entrance surface of the light guide plate are likely to vary. This causes variation in the light entrance efficiency of light entering the light entrance surfaces from the light sources, and this may cause unevenness in the light exiting from each light guide plate.

### DISCLOSURE OF THE PRESENT INVENTION

The present invention was accomplished in view of the above circumstances. It is an object of the present invention to control whether or not to exit light for each small area of a light guide member.

### Means for Solving the Problem

To solve the above problem, a lighting device of the present invention includes a plurality of light sources, alight guide member having a light entrance surface which light from the plurality of light sources enters and a light exit surface from which light exits and a groove portion formed on a surface of the light guide member opposite to the light exit surface so as to divide the light exit surface into a plurality of areas in a plan view. The light sources are arranged corresponding to each of the areas; and the groove portion includes a light source housing groove portion housing at least one of the light sources therein and having an inner surface that is the light entrance surface.

With such a configuration, the groove portions divide the light exit surface of the light guide member into a plurality of areas in a plan view. A plurality of light sources is arranged in association with a plurality of areas. Therefore, by controlling driving of each of the light sources, it can be selectively controlled whether or not to exit light from the light exit surface for each area. Namely, local dimming control is made possible.

In the present invention, the light guide member is defined into plurality of areas by the groove portions. The size of each area that is a unit for controlling light exit can be set freely, and therefore it can be controlled whether or not to exit light for each small area. Unlike a conventional case, the light guide member is not divided into a plurality of pieces. Therefore, good operability is provided for mounting of the light guide member. Furthermore, the groove portions include the light source housing groove portions that house the light sources therein and the inner surfaces of the light source housing groove portions are used as the light entrance surfaces. If the light guide member is divided into a plurality of light guide plates like a conventional configuration, positional relationships between the light sources and the light entrance surfaces of the light guide members are likely to vary. Compared to such a conventional configuration, the positional relationships between each of the light sources and the light entrance surface associated with each area A are constant. Namely, the light entrance efficiency of the light from each light source entering the light entrance surface is kept to be constant, and therefore, unevenness is less likely to be caused in the light exiting from each area. The light source housing groove portions are formed on a surface that is opposite to the light exit surface, and therefore, the light sources housed in the light source housing groove portions are less likely to be recognized.

Following configurations may be preferable.

(1) Each of the light sources may have a light emitting surface, at least a pair of the light sources may be arranged in the light source housing groove portion such that the light emitting surfaces of the pair of light sources face in opposite directions, and the light source housing groove portion may have a pair of inner surfaces that faces the pair of light sources and each of the inner surfaces is the light entrance surface.

With such a configuration, light from a pair of light sources enters a pair of areas through a pair of light entrance surfaces. The two adjacent areas are arranged to sandwich the light source housing groove portion. This reduces the number of the light source housing groove portions and spaces for mounting the light sources, compared to a configuration in which a single light source is housed in each light source housing groove portion.

(2) At least the pair of the light sources may be arranged so as to sandwich each of the areas. With such a configuration, light from at least a pair of the light sources that are arranged to sandwich each area enters the area. This improves uniform brightness of exiting light from the light exit surface.

(3) Alight source board on which the light sources are mounted may be included. With such a configuration, a plurality of light sources is mounted on the light source board and the positional relationships between each of the light sources and each of the light entrance surfaces of the light guide member are less likely to vary and uneven brightness is less likely to occur. Furthermore, the light sources are easily installed in the lighting device.

(4) The light source board may include a base member and a mount board. The base member may extend along a surface of the light guide member that is opposite to the light exit surface and the mount board may be provided to protrude from the base member toward an inner side of the light source housing groove portion. With such a configuration, the light sources are mounted on the mount board that protrudes from the base member toward the light source housing groove portion. Therefore, the light sources are properly positioned with respect to the light entrance surface.

(5) The mount board may have a pair of surfaces that face in opposite directions and the light sources may be mounted on each of the pair of surfaces, and the light source housing groove portion may have a pair of inner surfaces and each of the inner surfaces is the light entrance surface. With such a configuration, light from the pair of light sources that are mounted on the mount board enters the pair of light entrance surfaces and travels into a pair of areas that are provided adjacent to each other to sandwich the light source housing groove portion. The light sources are mounted on each of the surfaces that face in opposite directions in the mount board. The number of mount boards and the width of the light source housing groove portion can be reduced compared to a configuration in which a single light source is mounted on a single mount board.

(6) The mount board may include a plurality of mount boards and the mount boards may be arranged to be away from each other, and each of the mount boards may correspond to each of the areas of the light guide member that are defined by the groove portion. With such a configuration, each of the mount boards is arranged in every area A in a distributed manner. Even if the light source has an error, only the mount board on which the light source having an error is mounted is necessary to be replaced with another one or repaired. Accordingly, this solves the problem at low cost.

(7) The plurality of light sources may be mounted on the mount board. The light sources may be connected each other in series. With such a configuration, the light sources are arranged effectively. Furthermore, such a configuration improves brightness of light exiting from each of the areas that are associated with the light sources that are mounted on the mount board.

(8) The light sources may be arranged substantially at equal intervals on the mount board. Such a configuration improves evenness of the light exiting from the each area that is associated with the light sources that are mounted on the mount board.

(9) The base member may has a size so as to cover the plurality of areas of the light guide member. Heat generated from the light sources is conducted to the base member through the mount board. The base member is large as to cover the areas, and this improves heat dissipation.

(10) The base member may has substantially the same size as an entire surface area of the light guide member that is opposite to the light exit surface. Such a configuration improves heat dissipation.

(11) The groove portion may include a plurality of groove portions. At least a pair of the groove portions may be formed so as to cross each other. The light guide member may be divided such that the plurality of areas is arranged in a row direction and a column direction in a plan view. With such a configuration, the light guide member is defined into small areas arranged in columns and rows by the groove portions. Therefore, it is controlled whether or not to exit light from the light exit surface for each small area.

(12) The plurality of groove portions may include the groove portions extending in the row direction and the groove portions extending in the column direction. With such a configuration, a plurality of groove portions that cross each other is formed, and accordingly, the light guide member is effectively divided into smaller areas.

(13) The plurality of groove portions may be arranged such that each of the areas substantially has the same size. With such a configuration, the each area that are defined by the groove portions substantially has a same size, and this achieves substantially a same size of a unit from which it is controlled whether or not to exit light.

(14) The same number of the light sources may be provided for each of the areas. With such a configuration, the same amount of light is supplied to each area that has the substantially same size. This unifies brightness of light exiting from each area.

(15) One of the pair of the groove portions crossing each other may be the light source housing groove portion. With such a configuration, one of the groove portions is the light source housing groove portion that houses the light sources therein and the other one of the groove portions does not house the light sources therein. The width of the other groove portion in which no light source is housed can be reduced compared to that of the one groove portion housing the light sources.

(16) The light guide member may have an outer side surface provided in parallel with the light source housing groove portion and the outer side surface may face the light sources. The outer side surface of the light guide member may be the light entrance surface. With such a configuration, each of the adjacent area A that are arranged along the LED housing groove portion 22A receives light from the light sources facing the light entrance surface that is the inner surface of the light source housing groove portion and also receives light from the light sources facing the light entrance surface that is the outer side surface of the light guide member that is parallel with the light source housing groove portion. This further improves uniformity of brightness in the light that exits from the light exit surface.

(17) The light source housing groove portion may include a plurality of light source housing groove portions and the at least the pair of groove portions crossing each other may be the light source housing groove portion. With such a configuration, at least a pair of groove portions crossing each other is both the light source housing groove portions, and therefore, the light sources are arranged in a distributed manner in a wide area. This improves exiting light with uniform brightness.

(18) All the groove portions may be the light source housing groove portions. With such a configuration, the light sources are arranged to be distributed in a wider area within the light exit surface. This further improves exiting light with uniform brightness.

(19) The light guide member may have an outer peripheral side surface and substantially all the outer peripheral side surface may face the plurality of light sources; and the outer peripheral side surface may be the light entrance surface. With such a configuration, each of the areas A that are provided along the light source housing groove portion receives light from the light entrance surface that is the inner surface of the light source housing groove portion and also receives light from the light entrance surface that is the outer peripheral side surface of the light guide member. This further improves exiting light in uniformity of brightness.

(20) The groove portion may have an opening on the outer side surface of the light guide member and on the surface of the light guide member that is opposite to the light exit surface. With such a configuration, the groove portions have openings not only on the surface that is opposite to the light exit surface of the light guide member but also on the outer side surfaces of the light guide member. Accordingly, air inside the groove portions easily flows outside. Therefore, heat generated from the light sources housed in the light source housing groove portion can be effectively dissipated outside.

(21) The lighting device may further include a diffuser lens between the light sources and the light entrance surface and configured to diffuse light from the light sources. With such a configuration, light emitted from the light sources is diffused through the diffuser lens and enters the light entrance surface. Therefore, even if the number of light sources is small, exiting light from the area associated with the light sources is further improved in uniformity of brightness.

(22) The light sources may be mounted on the light source board and the diffuser lens may be provided on the light source board. With such a configuration, the diffuser lenses are provided on the light source board on which the light sources are mounted. Therefore, the positional relationships between the light sources, the diffuser lenses and the light entrance surfaces of the light guide member are less likely to vary and uneven brightness is less likely to occur.

(23) The lighting device may further include a reflection member. The diffuser lens may have the light exit surface directed to one of the areas that are adjacent to each other so as to sandwich the light source housing groove portion and is arranged so as to cover the light sources from the one of the areas and the reflection member may be arranged close to another one of the areas with respect to the light source and the areas may be adjacent to each other so as to sandwich the light source housing groove portion, and the reflection member may be configured to reflect light toward the one of the areas. With such a configuration, light emitted from the light source directly enters the diffuser lens, or reflects off the reflection member and indirectly enters the diffuser lens. The light exits from the light exit surface of the diffuser lens toward the one of the areas. Therefore, light is effectively supplied to one area, thereby improve brightness.

(24) The lighting device may further include a reflection portion provided on a surface of the light guide member that is opposite to the light exit surface and configured to reflect light. With such a configuration, the reflection portion reflects light that enters the light entrance surface. Therefore, light travels effectively within light guide member.

(25) The light sources may be LEDs. This achieves improved brightness and low power consumption.

Next, to solve the above problem, a display device of the present invention may include the above lighting device and a display panel configured to provide display using light from the lighting device.

In such a display device, the lighting device that supplies light to the display panel controls whether or not to exit light for each small area of the light guide member. This achieves display having excellent display quality.

The display panel may be a liquid crystal panel. The display device as a liquid crystal display device has a variety of applications, such as a television display or a personal-computer display. Particularly, it is suitable for a large screen display.

### Advantageous Effect of the Invention

According to the present invention, whether or not to exit light is controlled for each small area of the light guide plate and good operability is provided for mounting of the light guide member. Moreover, uneven brightness is less likely to occur.

### BRIEF DESCRIPTION OF THE DRAWINGS

FIG. 1 is an exploded perspective view illustrating a general configuration of a television receiver according to a first embodiment of the present invention;

FIG. 2 is an exploded perspective view illustrating a general configuration of a liquid crystal display device included in the television receiver;

FIG. 3 is a plan view illustrating an arrangement configuration of LED boards (LED) and a light guide member;

FIG. 4 is a cross-sectional view taken in the long-side direction of the liquid crystal display device;

FIG. 5 is a cross-sectional view taken in the short-side direction of the liquid crystal display device;

FIG. 6 is an enlarged cross-sectional view of FIG. 4;

FIG. 7 is a plan view illustrating an arrangement configuration of the LED boards (LED) and the light guide member according to a second embodiment of the present invention;

FIG. 8 is a plan view illustrating an arrangement configuration of the LED boards (LED) and the light guide member according to a third embodiment of the present invention;

FIG. 9 is a plan view illustrating an a sectional configuration of the LED boards (LED) and the light guide member according to a fourth embodiment of the present invention;

FIG. 10 is a plan view illustrating an arrangement configuration of the LED boards (LED) and the light guide member; and

FIG. 11 is a plan view illustrating an arrangement configuration of the LED boards (LED) and the light guide member according to a fifth embodiment of the present invention.

### BEST MODE FOR CARRYING OUT THE INVENTION

### First Embodiment

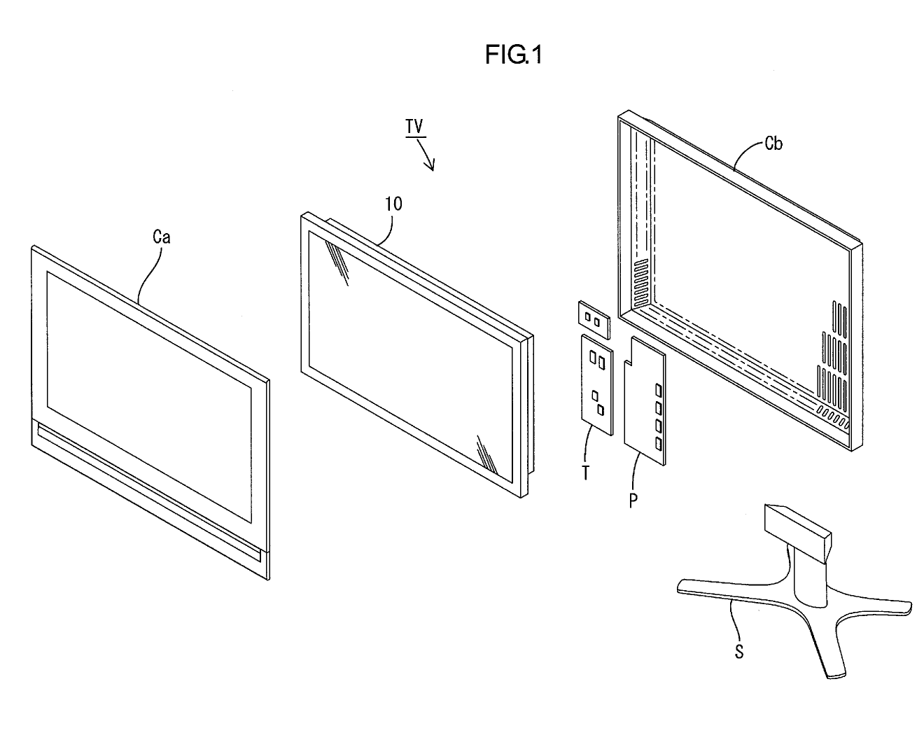

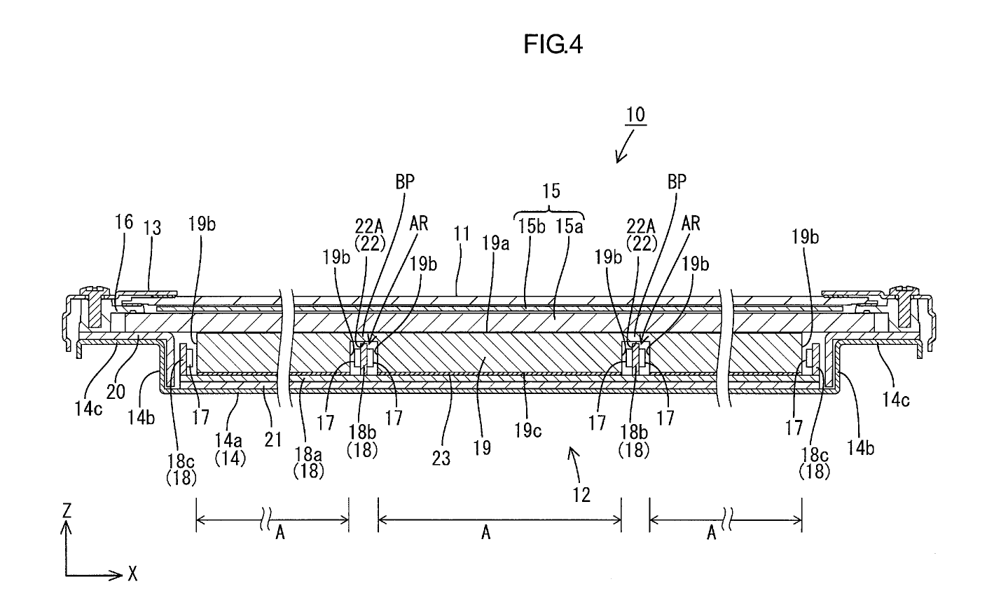

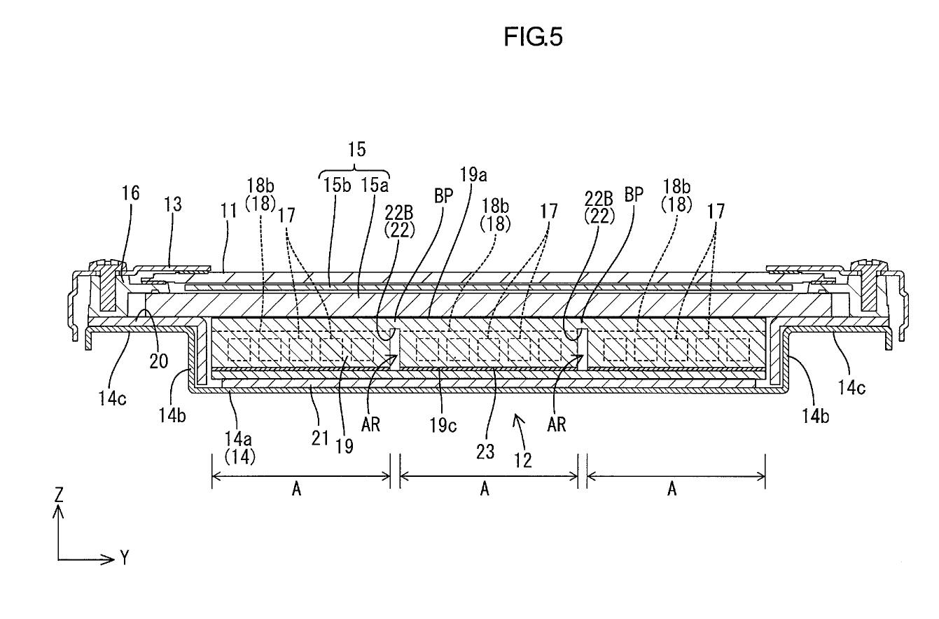

A first embodiment of the present invention will be described with reference to FIGS. 1 to 6. In the present embodiment, a liquid crystal display device 10 will be explained. An X axis, a Y-axis and a Z-axis are described in a part of the drawings, and a direction of each axial direction corresponds to a direction described in each drawing. An upper side in FIGS. 4 and 5 corresponds to a front-surface side and a lower side in FIGS. 4 and 5 corresponds to a rear-surface side.

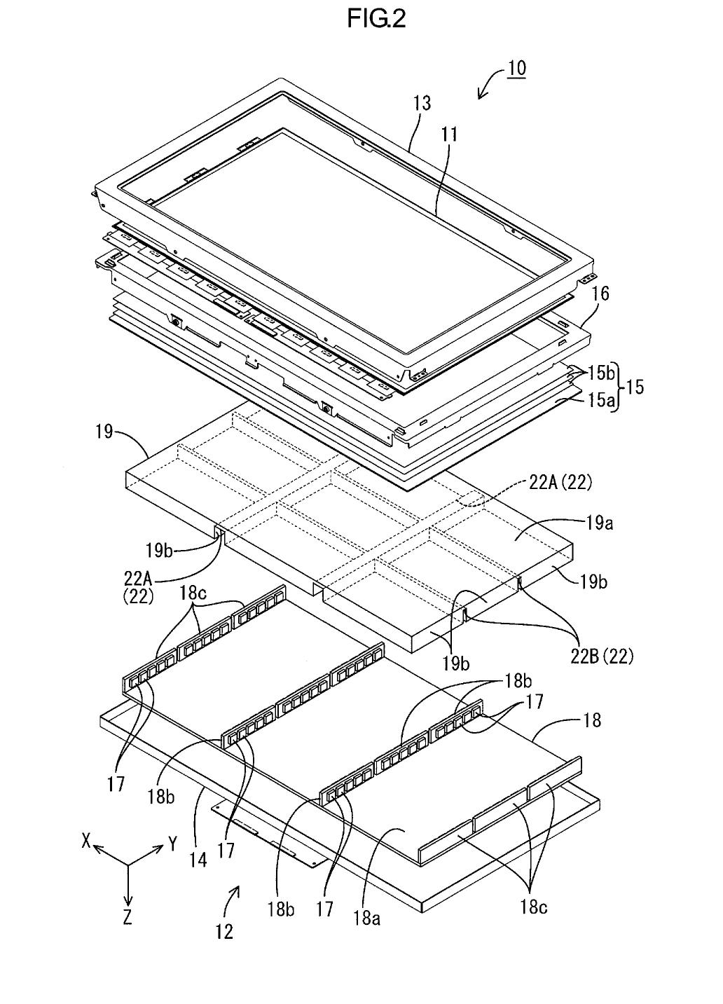

As illustrated in FIG. 1, the television receiver TV of the present embodiment includes the liquid crystal display device 10, front and rear cabinets Ca, Cb which house the liquid crystal display device 10 therebetween, a power source P, a tuner T and a stand S. An entire shape of the liquid crystal display device (display device) 10 is a landscape rectangular. The liquid crystal display device 10 is housed in a vertical position. As illustrated in FIG. 2, the liquid crystal display device 10 includes a liquid crystal panel 11 as a display panel, and a backlight unit (lighting device) 12 as an external light source. The liquid crystal panel 11 and the backlight unit 12 are integrally held by a frame shaped bezel 13 and the like.

As illustrated in FIG. 2, the liquid crystal panel 11 is formed in a rectangular shape in a plan view and is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. Polarizing plates are attached to outer surfaces of the substrates.

As illustrated in FIG. 2, the backlight unit 12 includes a chassis 14, an optical sheet set 15 (a diffuser (light diffusing member) 15a, and a plurality of optical sheets 15b which is provided between the diffuser 15a and the liquid crystal panel 11). The chassis 14 has a substantially box-shape and has an opening 14b on the light exit side (on the liquid crystal panel 11 side). The optical member 15 is provided so as to cover the opening 14b of the chassis 14. Furthermore, LEDs 17 (light emitting diodes) that are a light source, an LED board 18 (a light source board) on which the LEDs 17 are mounted and a light guide member 19 that guides light from the LEDs 17 to the optical member 15 (liquid crystal panel 11). As illustrated in FIG. 4, the backlight unit 12 includes a receiving member 20 that receives the optical member 15 from the rear-surface side, a holding member 16 that holds the optical member 15 from the front-surface side and a heat sink 21 for hastening the dissipation of heat that is generated in accordance with emission of the LEDs 17. In FIG. 2, the receiving member 20 and the heat sink 21 are not illustrated. In the following, each component of the backlight unit 12 will be explained.

The chassis 14 is made of metal. As illustrated in FIGS. 4 and 5, the chassis 14 includes a rectangular bottom plate 14a like the liquid crystal panel 11, side plates 14b each of which rises from an outer edge of the corresponding side of the bottom plate 14a, and a receiving plate 14c outwardly extending from a rising edge of each of the side plates 14b. An entire shape of the chassis 14 is a substantially shallow box shape (shallow plate shape) opened to the front-surface side. A long side of the chassis 14 (bottom plate 14a) matches an X-axis direction (a horizontal direction) and a short side thereof matches a Y-axis direction (a vertical direction). The receiving member 20 and the holding member 16 can be placed on the receiving plate 14c of the chassis 14 from the front-surface side. The bezel 13, the receiving member 20 and the holding member 16 can be fixed to each receiving plate 14c by screws. A mounting mechanism (not shown) for mounting the LED board 17 and the light guide member 19 on the bottom plate 14a is provided. For example, in mounting the LED board 17 and the light guide member 19 by screws, the mounting mechanism is a screw hole to which screw members are fastened or a screw fitting hole through which screw members are fitted.

As illustrated in FIG. 2, the optical member 15 is formed in a rectangular landscape in a plan view like the liquid crystal panel 11 and the chassis 14. The optical member 15 is placed on the front-surface side (light exit side) of the light guide member 19 and provided between the liquid crystal panel 11 and the light guide member 19. The optical member 15 includes a diffuser 15a and an optical sheet 15b. The diffuser 15a is provided on the rear-surface side (the light guide member 19 side, a side opposite from the light exit side) and the optical sheet 15b is provided on the front-surface side (the liquid crystal panel 11 side, the light exit side). The diffuser 15a includes a base member having a thickness and made of a substantially transparent synthetic resin and light scattering particles dispersed in the base member. The diffuser 15a has a function for diffusing light that transmitting therethrough. The optical sheet 15b is formed in a sheet having a thickness smaller than the diffuser 15a and includes laminated three layers. A specific optical sheet 15b may include a diffuser sheet, a lens sheet, a reflecting type polarizing sheet, and any one of them may be selected to be used.

The holding member 16 and the receiving member 20 are formed in a frame shape and provided along the outer periphery of the liquid crystal panel 11 and the optical member 15. As illustrated in FIGS. 4 and 5, the receiving member 20 is directly placed on the receiving plate 14c of the chassis 14 and receives the outer periphery of the rear side of the diffuser 15a of the optical member 15 from the rear-surface side. The holding member 16 is placed on the receiving member 20 and can hold the diffuser 15a of the optical member 15 from the front-surface side. Accordingly, the receiving member 20 and the holding member 16a sandwich the diffuser 15a. Furthermore, the holding member 16 holds the outer periphery of the liquid crystal panel 11 from the rear-surface side. The bezel 13 holds the outer periphery of the liquid crystal panel 11 from the front-surface side. The holding member 16 and the bezel 13 sandwich the liquid crystal panel 11. The bezel 13 is formed in a frame shape so as to surround a display area of the liquid crystal panel 11 like the receiving member 20 and the holding member 16.

The sheet-like heat sink 21 is made of a synthetic resin or metal having high heat conductivity. As illustrated in FIGS. 4 and 5, the heat sink 21 is provided along the inner surface of the bottom plate 14a of the chassis 14. The heat sink 21 is almost as large as the entire surface of the bottom plate 14a and the LED board 18 (described later). The heat sink 21 is sandwiched between the bottom plate 14a and the LED board 18.

As illustrated in FIG. 4, the LED 17 is configured by sealing an LED chip with a resin material onto a base board that is fixed to the LED board 18. The LED chip that is mounted on the base board has one main light emission wavelength and specifically, the LED chip that emits a single color of blue is used. On the other hand, a fluorescent material is dispersed in the resin material that seals the LED chip therein. The fluorescent material converts blue light emitted from the LED chip into white light. This enables the LED 17 to emit white light. The LED 17 may include combinations or single use of three different kinds of fluorescent material, each of which is a yellow fluorescent material emitting yellow light, a green fluorescent material emitting green light or a red fluorescent material emitting red light. The LED 17 is a top-type LED that has a light emitting surface 17a on a surface opposite from the mounting surface that is to be mounted to the LED board 18.

As illustrated in FIGS. 2 to 4, the LED board 18 is made of a synthetic resin (for example, an epoxy resin) and has a surface having white color that provides excellent light reflectivity. The LED board 18 includes a base board 18a and mount boards 18b and 18c. The base board 18a extends along the bottom plate 14a of the chassis 14 (along a surface 19c of the light guide member 19 that is opposite to a light exit surface 19a thereof). The mount boards 18b and 18c on which the LEDs 17 are mounted rise from the base board 18a toward the front-surface side (the light guide member 19 side). The base board 18a is formed in a landscape rectangular in a plan view similar to the bottom plate 14a and is almost as large as an entire surface of the bottom plate 14a (the light guide member 19). The base board 18a is placed on the heat sink 21. The long side of the base board 18a is longer than that of the light guide member 19 (described later). The both ends of the long side of the base board 18a extend outwardly compared to the both ends of the long side of the light guide member 19 (FIG. 4). A wiring pattern (not shown) made of a metallic film is formed on the base board 18a. The base board 18a is electronically connected with the mount boards 18b and 18c described later through the wiring pattern and with an outer control board (not shown) through connecting parts including flexible printed circuits. The control board supplies power required to light on the LED 17 to drive and control the LED 17.

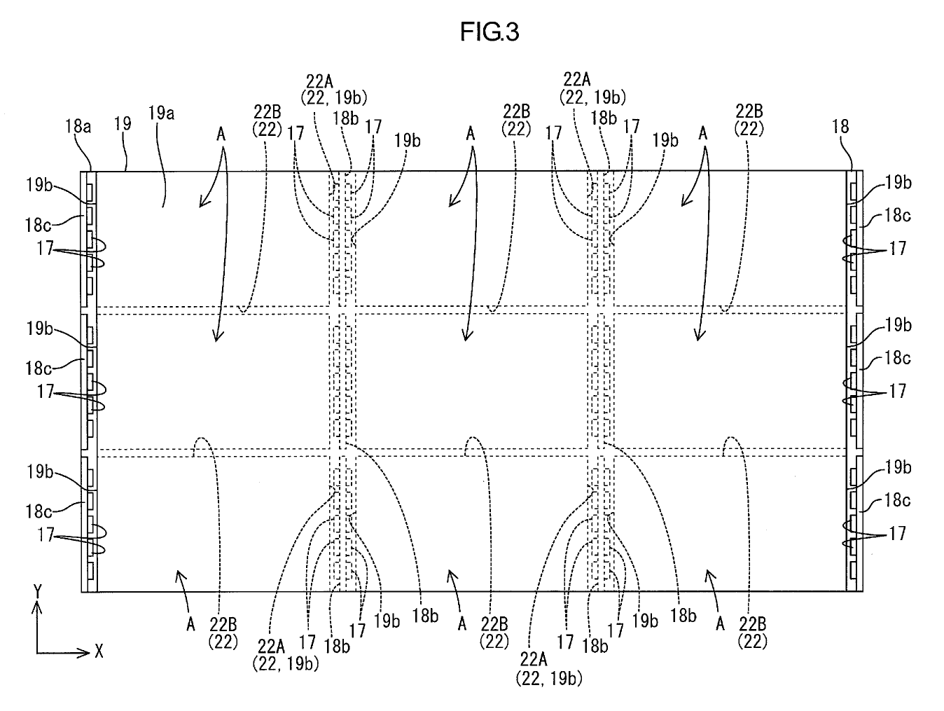

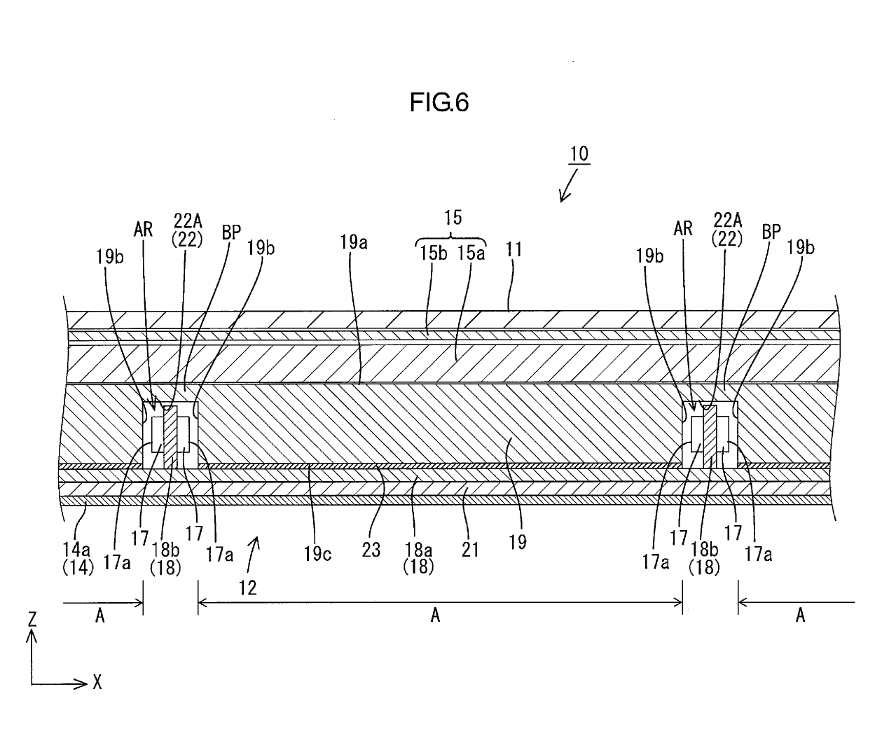

As illustrated in FIG. 3, a plurality of mount boards 18b and 18c is arranged in a distributed manner on a main plate surface of the base board 18a that faces the front-surface side. The mount boards 18b and 18c are arranged along the long side of the base board 18a so as to be away from each other. Specifically, the mount boards 18b and 18c are arranged on both ends of the long-side (in the X-axis direction) of the base board 18a and two positions near the middle part of the long side of the base board 18a. The mount boards 18b and 18c are arranged at total of four positions. The mount boards 18b and 18c are arranged at positions in the X-axis direction so as to define the long side of the base board 18a (the light guide member 19) into three portions each of which has substantially an equal area. As illustrated in FIGS. 4 and 6, the mount boards 18b and 18c are provided so as to be raised approximately perpendicular to the base board 18a. The main plate surface of each of the mount boards 18b, 18c is perpendicular to the main plate surface of the base board 18a. As illustrated in FIGS. 2 and 5, each of the mount boards 18b and 18c is formed in a landscape rectangular with a side view. The long side of each of the mount boards 18b and 18c matches a Y-axis direction, the short side thereof matches a Z-axis direction, and the thickness of the plate thereof matches an X-axis direction. As illustrated in FIGS. 3 and 5, the three mount boards 18b and 18c are arranged on the base board 18a linearly in the short-side (the Y-axis) direction of the base board 18a. In other words, the mount boards 18b and 18c are arranged so as to divide the short side of the base board 18a into three equal parts. Each of the three mount boards 18b and 18c has substantially the same size. The mount boards 18b and 18c are arranged to be away from each other such that each mount board has a size corresponding to an area A of the light guide member 19 described later. Therefore, as illustrated in FIGS. 2 and 3, the mount boards 18b and 18c are arranged in a distributed manner at four positions with a relatively wide gap therebetween in the X-axis direction and three positions with a relatively narrow gap therebetween in the Y-axis direction. A total of twelve mount boards are integrally provided on the base board 18a.

As illustrated in FIGS. 3 and 5, five LEDs 17 are arranged linearly on the main plate surface of each mount board 18b and 18c in the long-side direction (the Y-axis direction) thereof. The gaps between the adjacent LEDs 17, namely, arrangement pitches of the LEDs 17 on each mount board 18b and 18c, are almost the same. As illustrated in FIGS. 3 and 4, a light axis of light emitted from the light emitting surface 17a of each mounted LED 17 approximately matches the direction perpendicular to the main plate surface of the mount board 18b and 18c (the thickness direction of the mount board 18b and 18c and the X-axis direction). A wiring pattern (not shown) formed on each mount board 18b and 18c is connected in series with the mounted LEDs 17 each other. The wiring pattern is electrically connected with a wiring pattern on the base board 18a side.

The mount boards 18b and 18c include two types of a single-side mount board and a double-side mount board. In the single-side mount board, the LEDs 17 are mounted on a single side of the mount board. In the double-side mount board, the LEDs 17 are mounted on both sides of the mount board. Specifically, the mount boards 18c are arranged on both ends of the X-axis in the base board 18a. The LEDs 17 are mounted only on an inner surface of the main plate of the mount board 18c. Namely, the LEDs 17 are mounted only on a surface that faces the light guide member 19. The mount boards 18c are single-side mount boards. The mount boards 18b are arranged at two positions near the middle of the base board 18a in the X-axis direction (positions sandwiched between the single-side mount boards 18c). The LEDs 17 are mounted on both surfaces of the main plate of the mount board 18b. The mount boards 18b are double-side mount boards. In the double-side mount board 18b, the LEDs 17 in pairs are arranged so as to sandwich the mount board 18b. The light emitting surfaces 17a of the LEDs 17 in pairs face in opposite directions at an angle of 180 degrees to each other.

Next, the light guide member 19 will be explained in detail. The light guide member 19 is made of a synthetic resin (such as acrylic) that is substantially transparent (has highly capable of light transmission) and has refraction index higher than air. As illustrated in FIG. 2, the light guide member 19 is formed in a landscape rectangular plan view shape similar to the liquid crystal panel 11 and the chassis 22a. A long-side direction of light guide member 19 matches the X-axis direction and a short-side direction thereof matches the Y-axis direction. The light guide member 19 that is formed in a plate shape extends along the optical member 15, the bottom plate 14a and the base board 18a of the LED board 18. The main plate surface of the light guide member 19 is arranged in the X-axis direction and the Y-axis direction. The light guide member 19 is arranged directly below the liquid crystal panel 11 and the optical member 15 within the chassis 14. A main plate surface of the light guide member 19 on the front-surface side (namely, the optical member 15 side) is a light exit surface 19a configured to direct internal light to the optical member 15 and the liquid crystal panel 11. The light guide member 19 has a thickness (plate thickness dimension) substantially as same as the rising height of the side plate 14b of the chassis 14.

As illustrated in FIGS. 2 to 5, a groove portion 22 is formed in a rear surface 19c of the main plate surface of the light guide member 19, namely, in the surface 19c that is opposite to the light exit surface 19a. The groove portion 22 is arranged so as to define the light exit surface 19a into a plurality of areas A in a plan view. An air layer AR is formed within the groove portion 22 and light in the areas A of the light guide member 19 totally reflects off an interface between the light guide member 19 and the air layer AR. Accordingly, light that is directed inside the groove portion 22 (outside the areas A) is controlled (FIGS. 4 and 5). Therefore, light is controlled such that light travels within the areas A into which the light guide member 19 is defined, thereby assuring optical independence in each area A. The groove portion 22 is formed in the surface 19c of the light guide member 19 that is opposite to the light exit surface 19a thereof and does not have an opening on the light exit surface 19a. Accordingly, the light exit surface 19a is substantially flat over an entire surface area of the light guide member 19 in a plan view. In a sense, the areas A of the light guide member 19 are connected each other via bridge portions BP that are arranged at positions that overlap the groove portions 22 in a plan view (FIGS. 4 and 5). The groove portions 22 include an LED housing groove portion 22A and a defining groove portion 22B. The LED housing groove portion 22A houses the mount board 18b and the LEDs mounted thereon. The mount board 18b protrudes from the base board 18a of the LED board 18 toward the front-surface side. The defining groove portion 22B merely defines the light guide member 19 into a plurality portions. The defining groove portion 22B does not house the mount board 18b or LEDs 17 therein. In the following description, the LED housing groove portion 22A is distinguished from the defining groove portion 22B by adding “A” to the symbols representing the components related to the LED housing groove portion 22A and adding “B” to the symbols representing the components related to the defining groove portion 22B. Nothing is added to the symbols if not necessary to distinguish one from another.

As illustrated in FIG. 3, the LED housing groove portions 22A are formed to be parallel to the short-side direction (the Y-axis direction) of the light guide member 19. Namely, the LED housing groove portions 22A are arranged in parallel with the main plate surfaces of the mount boards 18b housed therein (in parallel with the direction in which the LEDs 17 are aligned). The defining groove portions 22B are formed to be parallel to the long-side direction (the X-axis direction) of the light guide member 19. Namely, the defining groove portions 22B are arranged in the direction perpendicular to the main plate surfaces of the mount boards 18b (arranged along the light axes of the LEDs 17). The groove portions 22A and 22B are substantially perpendicular to each other (cross each other). Therefore, the LED housing groove portions 22A and the defining groove portions 22B define the light guide member 19 into a plurality of areas A in a row direction and a column direction (in a matrix) in a plan view. Specifically, two LED housing groove portions 22A are formed so as to be away from each other in the X-axis direction and each of the two LED housing groove portions 22A extends over an entire length of a short side of the light guide member 19. Two defining groove portions 22B are formed so as to be away from each other in the Y-axis direction and each of the two defining groove portions 22B extends over an entire length of a long side of the light guide member 19. Accordingly, three areas A are arranged parallel to each other in the long-side direction (the X-axis direction) of the light guide member 19 and three areas A are arranged parallel to each other in the short-side direction (the Y-axis direction). Accordingly, the light guide member 19 is divided into total of nine areas A.

As illustrated in FIG. 3, the LED housing groove portions 22A are arranged so as to overlap the double-side mount boards 18b that are arranged in the middle part of the long-side direction of the LED board 18. The LED housing groove portions 22A are arranged at the positions so as to define a long side of the light guide member 19 into three portions each of which has substantially an equal area. Similarly, the defining groove portions 22B are arranged at the positions so as to define a short side of the light guide member 19 into three portions each of which has substantially an equal area. A width of each of the three parts is substantially equal to the length of each of the three mount boards 18b and 18c arranged in the Y-axis direction. Thus, the light guide member 19 is defined into the areas A by the groove portions 22A and 22B and each of the areas A has substantially the same size (an area or a square measure). Each area A is formed in a rectangular plan view shape similar to the light guide member 19. A horizontal to vertical ratio of each area A is substantially as same as that ratio of the light guide member 19. As illustrated in FIG. 2, groove portions 22A and 22B have openings on the rear side surface 19c and the outer side surfaces of the light guide member 19. Air easily flows into and out of the groove portions 22A and 22B.

As illustrated in FIG. 3, the LED housing groove portion 22A is wider than the defining groove portion 22B so as to house the double-side mount board 18b with the LEDs 17 therein. The LED housing groove portion 22A has a width (a dimension in the X-axis direction) wider than the thickness of the mount board 18b including the LEDs 17 and has a depth (a dimension in the Z-axis direction) greater than the height of the mount board 18b. The LED housing groove portion 22A extends over the entire length of the short side of the light guide member 19, and collectively houses three mount boards 18b that are arranged in the Y-axis direction in the LED housing groove portion 22A. A part of the inner peripheral surface of the LED housing groove portion 22A is the light entrance surface 19b. The part of the inner peripheral surface of the LED housing groove portion 22A faces the main plate surface of the mount board 18b and the light emitting surface 17a of the LED 17. Light from the LED 17 is directed through the light entrance surfaces 19b into the light guide member 19. Here, the mount board 18b housed in the LED housing groove portion 22A is a double-side mount board on both surfaces of which the LEDs 17 are mounted to face in opposite directions. The light entrance surfaces 19b are provided on a part of the inner peripheral surface of the LED housing groove portion 22A and are inner surfaces thereof in the pair facing each other. The light guide member 19 is provided so as to be sandwiched by the single-side mount boards 18c that are arranged on both ends of the long-sides of the LED board 18. Two outer side surfaces in the long-side direction of the light guide member 19 face the LEDs 17 that are mounted on the single-side mount boards 18c. The outer side surfaces of the light guide member 19 are the light entrance surfaces 19b through which light from the LED 17 is directed within the light guide member 19. The LEDs 17 and the light entrance surfaces 19b are arranged in the X-axis direction. The optical member 15 (the liquid crystal panel 11) and the light guide member 19 are arranged in the Z-axis direction. The arrangement direction of the LEDs 17 and the light entrance surfaces 19b is perpendicular to the arrangement direction of the optical member 15 and the light guide member 19. Light emitted from the LEDs 17 in the X-axis direction enters the light guide member 19 and travels through the light guide member 19 to direct the light toward the optical member 15 (in the Z-axis direction). The light entrance surface 19b is substantially perpendicular to both the light exit surface 19a and the light axes of the LEDs 17.

As illustrated in FIG. 3, the light entrance surface 19b is provided in parallel with the main plate surfaces of the mount boards 18b and 18c (along the Z-axis and the Y-axis) and so as to be away from the light emitting surfaces 17a of the LEDs 17. The defining groove portions 22B divide the light entrance surface 19b into three portions for each area A in the Y-axis direction. Each divided light entrance surface 19b faces the five LEDs 17 on each mount board 18b corresponding to each area A. Accordingly, the equal number of LEDs 17 faces each light entrance surface 19b that is associated with each area A. The LEDs 17, every five of which are mounted on each mount board 18b and 18c, are arranged symmetrically so as to sandwich each area A of the light guide member 19 in the X-axis direction. Light emitted from the ten LEDs 17 enters each area A. Accordingly, the number of LEDs 17 that supply light to each area A is all the same. Here, the five LEDs 17 that are arranged linearly on the main plate surface on each mount board 18b and 18c are driven as a unit. This makes it possible to control light supply to each area A individually. As explained before, the groove portions 22 assure optical independence of the areas A in the light guide member 19 according to the present embodiment. By controlling driving of the LEDs 17 as explained before, it is selectively controlled to whether or not to exit light from the light exit surface 19a for each defined area A.

As illustrated in FIGS. 4 and 5, the reflection sheet 23 is configured to reflect light within the light guide member 19 to direct the light to the front-surface side. The reflection sheet 23 is arranged so as to cover the entire surface 19c of the light guide member 19 that is opposite to the light exit surface 19a thereof. However, the reflection sheet 23 does not cover the groove portions 22A or 22B. Light that enters the light guide member 19 through the light entrance surface 19b is reflected repeatedly by the reflection sheet 23 to travel effectively within the light guide member 19. A reflection section configured to reflect inner light (not shown) or a dispersion section configured to disperse inner light (not shown) is patterned so as to have predetermined distribution in a surface area of at least one of the light exit surface 19a and the opposite surface 19c of the light guide member 19. With this configuration, light exiting from the light exit surface 19a is controlled so as to be uniformly distributed in the light exit surface 19a.

The construction of the present embodiment has been explained above and an operation thereof will be explained. The liquid crystal panel 11, the backlight unit 12 and the bezel 13 are separately manufactured and they are assembled to each other with and the like. Accordingly, the liquid crystal display device 10 is manufactured. An assembling operation in manufacturing the backlight unit 12 will be explained in detail.

The heat sink 21 is housed in the chassis 14, and then, the LED board 18 including the base board 18a and the mount boards 18b and 18c mounted thereon is housed in the chassis 14. The receiving members 20 are housed in the chassis 14. Next, the light guide member 19 will be arranged in the chassis 14. The light guide member 19 is positioned such that an entire thereof fits in a space between a pair of the single-side mount boards 18c that is arranged on both ends of the LED board 18 in its long-side direction. Also, the light guide member 19 is positioned such that each LED housing groove portion 22A of the light guide member 19 corresponds to the double-side mount boards 18b that are provided in the middle part of the LED board 18 in the long-side direction thereof. Accordingly, the light guide member 19 is housed in the chassis 14. In the present embodiment, the light guide member 19 is not divided into a plurality of light guide members and is a single component. Therefore, as long as positions of the components are adjusted each other, good operability is provided for assembling. Moreover, if the light guide member 19 is mounted on the correct position with respect to the LED board 18, each light entrance surface 19b of the light guide member 19 also has accurate positional relationships with the LEDs 17 of the LED board 18. Positional relationships between each LED 17 and each light entrance surface 19b are less likely to vary, compared to a configuration of dividing the light guide member into pieces. After the light guide member 19 is housed in the chassis 14, the optical members 15 are installed on the light guide member 19, and then the holding members 16 are assembled. Accordingly, the backlight unit 12 is manufactured.

The liquid crystal panel 11 and the like are assembled to the backlight unit 12. Accordingly, the liquid crystal display device 10 is manufactured. When the manufactured liquid crystal display device 10 is turned on, a control circuit (not shown) controls driving of the liquid crystal panel 11 and driving of each LED 17 in the backlight unit 12, and the liquid crystal panel 11 is illuminated with illumination light. Accordingly, images are displayed on the display surface of the liquid crystal panel 11. The operations according to the backlight unit 12 will be explained in detail.

As illustrated in FIG. 6, light emitted from the LEDs 17 that are lit enters the light entrance surface 19b of the light guide member 19. The light entering the light guide member 19 reflects off the reflection sheet 23 and totally reflects off the light exit surface 19a repeatedly. Accordingly, light travels through the light guide member 19 effectively. Here, the light guide member 19 is defined into nine areas A by the groove portions 22 each having the air layer AR therein. Among rays of light entering the areas A of the light guide member 19, rays of light that reach the edges at the outer surface of each area A almost totally reflect off an interface of the air layer AR. Accordingly, the rays of light are prevented from leaking in the groove portions 22 (out of the areas A). Therefore, by controlling turning on and off of the LEDs 17 that are provided to correspond to each area A (specifically, a five-LEDs 17 set that are arranged on each mount board 18b and 18c), it is selectively controlled whether or not to exit light from the light exit surface 19a for each area A. This enables local dimming control (area-active control). In the present embodiment, the light guide member 19 is defined by the groove portions 22 into small areas A such that the areas A are arranged in columns and rows. A size of each area A that is used a unit for controlling light exit becomes small. Therefore, lighting on and off in each area A can be controlled adequately in accordance with bright elements and dark elements of images to be displayed. This provides an advantage of increasing in contrast performance to achieve display having excellent display quality.

In the present embodiment, a size of each area A of the light guide member 19 is substantially equal to each other and the number of LEDs 17 configured to supply light to each area A is same, and therefore the amount of light exiting from each area A is approximately equal to each other. Accordingly, evenness of the brightness in a surface area of the light exit surface 19a is highly improved. Furthermore, the LEDs 17 are arranged symmetrically on both sides of each area A so as to sandwich each area A. Uniform amount of light is substantially supplied each area A. Accordingly, evenness of the brightness in the light exit surface 19a is highly improved. Furthermore, the base board 18a on which the mount boards 18b are mounted is provided over the areas A of the light guide member 19 and has a size substantially same as the light guide member 19. Even if the LEDs 17 generate heat according to light emission, the heat is effectively conducted from the base board 18a to the heat sink 21 and the base plate 14a of the chassis 14, thereby dissipating heat. Groove portions 22 have openings on the outer side surfaces of the light guide member 19. This easily flows air into and out of the groove portions 22. This also cools the LEDs 17 by air. Accordingly, improved heat dissipation is obtained. This is less likely to cause high temperature in the surroundings of the LEDs, thereby preventing emission efficiency of the LEDs 17 from being deteriorated. The areas A of the light guide member 19 that are defined by the groove portions 22 are connected each other via the bridge portions BP. Even though light from each area A may leak out to the adjacent areas A through the bridge portions BP, the amount of light that leaks is a little. Therefore, impact on display quality caused by the leakage of light is quite small. Instead, light that leaks out to the bridge portions BP provides an advantage that the mount boards 18b is less likely to be recognized from the front-surface side.

As explained above, the backlight unit 12 of the present embodiment includes the LEDs 17 that are a plurality of light sources, the light guide member 19 having the light entrance surface 19b and the light exit surface 19a. Light enters the light entrance surface 19b and exits from the light exit surface 19a. The surface 19c of the light guide member 19 is provided opposite to the light exit surface 19a thereof. The groove portions 22 are formed on the surface 19c. The groove portions 22 are arranged so as to define the light exit surface 19a in a plan view into a plurality of areas A. The LEDs 17 are arranged in association with the areas A. The groove portions 22 each house at least one of the LEDs 17 therein and include the LED housing groove portions 22A having inner surfaces as the light entrance surfaces 19b.

With such a configuration, the groove portions 22 define the light exit surface 19a of the light guide member 19 into a plurality of areas A in a plan view. The LEDs 17 are arranged in association with each area A. Therefore, by controlling driving of each of the LEDs 17, it can be selectively controlled whether or not to exit light from the light exit surface 19a for each area A. Namely, local dimming control is made possible.

In the present embodiment, the groove portions 22 define the light guide member 19 into a plurality of areas A. The size of each area A that is a unit for controlling light exit can be set freely, and therefore it can be controlled whether or not to exit light for each small area A. Unlike a conventional case, the light guide member 19 is not divided into a plurality of pieces. Therefore, good operability is provided for mounting of the light guide member 19. The groove portion 22 includes the LED housing groove portions 22A that house the LEDs 17 therein and the inner surfaces of the LED housing portions 22A are used as the light entrance surfaces 19b. If the light guide member 19 is divided into a plurality of light guide plates like a conventional configuration, positional relationships between the LEDs 17 and the light entrance surfaces 19b of the divided light guide plates are likely to vary. Compared to such a conventional configuration, in the present embodiment, the positional relationships are constant between each of the LEDs 17 and the light entrance surface 19b corresponding to each area A. Namely, the light entrance efficiency of the light entering the light entrance surface 19b from each LED 17 is kept to be constant, and therefore, unevenness is less likely to be caused in the light exiting from each area A. The LED housing groove portions 22A are formed on the surface 19c that is opposite to the light exit surface 19a, and therefore, the LEDs 17 housed in the LED housing groove portions are less likely to be recognized. According to the present embodiment, it is controlled to whether or not to exit light for each small area A of the light guide member 19. Good operability is provided for mounting of the light guide member 19. Moreover, uneven brightness is less likely to occur.

In the LED housing groove portion 22A, at least one pair of LEDs 17 is arranged such that the light emitting surfaces 17a thereof face in the opposite directions from each other. A pair of inner surfaces of the LED housing groove portion 22A that faces the one pair of LEDs 17 is the light entrance surfaces 19b. With such a configuration, light from a pair of LEDs 17 enters two adjacent areas A through a pair of light entrance surfaces 19b. The two adjacent areas A are arranged to sandwich the LED housing groove portion 22A. This reduces the number of LED housing groove portions 22A and spaces for mounting the LEDs 17, compared to a configuration in which a single LED is housed in each LED housing groove portion.

At least a pair of LEDs 17 is arranged so as to sandwich each area A. With such a configuration, light emitted from at least the pair of LEDs 17 arranged to sandwich each area A enters the area A. This improves uniform brightness of exiting light from the light exit surface 19a.

The LED board 18 on which a plurality of LEDs 17 are mounted is provided. With such a configuration, a plurality of LEDs 17 is mounted on the LED board 18 and therefore, the positional relationships between each of the LEDs 17 and the light entrance surface 19b are less likely to vary and uneven brightness is less likely to occur. Moreover, the LEDs 17 are easily installed in the backlight unit 12.

The LED board 18 includes the base board 18a and the mount board 18b. The base board 18a extends along the surface 19c of the light guide member 19 that is opposite to the light exit surface 19a thereof. The mount board 18b on which the LEDs 17 are mounted protrudes from the base board 18a toward the LED housing groove portion 22A. With such a configuration, the LEDs 17 are mounted on the mount board 18b that protrudes from the base board 18a toward the LED housing groove portion 22A. Therefore, the LEDs 17 are properly positioned with respect to the light entrance surface 19b.

The LEDs 17 are mounted on a pair of surfaces of the mount board 18b that face in opposite directions. A pair of the inner surfaces of the LED housing groove portion 22A is the light entrance surfaces 19b. With such a configuration, light from the pair of LEDs 17 mounted on the mount board 18b enters the pair of light entrance surfaces 19b and travels into a pair of areas A that are provided adjacent to each other to sandwich the LED housing groove portion 22A. The LEDs 17 are mounted on each of the surfaces of the mount board 18b that face in opposite directions. The number of mount boards 18b and the width of the LED housing groove portion 22A can be reduced compared to a configuration in which a single LED is mounted on a single mount board.

A plurality of mount boards 18b and 18c is arranged so as to be away from each other corresponding to each of the areas A of the light guide member 19 that are defined by the groove portions. With such a configuration, each of the mount boards 18b and 18c is arranged in every area A in a distributed manner. Even if the LED 17 has an error, only the mount board 18b or 18c on which the LED 17 having an error is mounted is necessary to be replaced with another one or repaired. Accordingly, this solves the problem at low cost.

A plurality of LEDs mounted on the mount boards 18b and 18c is connected in series. With such a configuration, the LEDs 17 are arranged effectively. Furthermore, such a configuration improves brightness of the light exiting from each of the areas A associated with the LEDs 17 that are mounted on the mount boards 18b and 18c.

The LEDs 17 are arranged at substantially equal intervals on the mount board 18b and 18c. Such a configuration improves evenness of the light exiting from each area A corresponding to the LEDs 17 mounted on the mount boards 18b and 18c.

The base board 18a is large as to cover a plurality of areas A of the light guide member 19. Heat generated from the LEDs 17 is conducted to the base board 18a through the mount boards 18b and 18c. The base board 18a is large as to cover a plurality of areas A, and this improves heat dissipation.

The base board 18a has substantially a same size as the entire surface 19c of the light guide member 19 that is opposite to the light exit surface 19a thereof. Such a configuration further improves heat dissipation.

At least a pair of groove portions 22 is formed so as to cross each other. The groove portions 22 define the light guide member 19 into a plurality of areas A arranged in rows and columns in a plan view. With such a configuration, the light guide member 19 is defined into a plurality of small areas A arranged in columns and rows by the groove portions 22. Therefore, it is controlled whether or not to exit light from the light exit surface 19a for every small area A.

The groove portions 22 include a plurality of groove portions that are formed in a row direction and another plurality groove portions that are formed in a column direction. The groove portions 22 are defined by the areas A that are arranged in a row direction and a column direction. With such a configuration, a plurality of groove portions 22 that cross each other are formed, and accordingly, the light guide member 18 can be effectively defined into smaller areas.

The groove portions 22 are arranged such that each of the defined areas A substantially has a same size. With such a configuration, each of the areas A that are defined by the groove portions 22 substantially has a same size, and this achieves substantially a same size of a unit from which it is controlled whether or not to exit light.

The same number of LEDs 17 are arranged for each of the areas A. With such a configuration, the same amount of light is supplied to each area A that has substantially the same size. This unifies brightness of light exiting from each area A.

One of the at least a pair of groove portions 22 that crosses each other is the LED housing groove portion 22A. With such a configuration, one of the groove portions 22 is the LED housing groove portion 22A that houses the LEDs 17 therein and the other one of the groove portions 22 (defining groove portion 22B) does not house the LEDs 17 therein. The width of the other groove portion 22 (defining groove portion 22B) in which no LED 17 is housed can be reduced compared to that of the one groove portion 22 housing the LEDs 17 (LED housing groove portion 22A).

The outer side surfaces of the light guide member 19 are provided in parallel with the LED housing groove portions 22A. The LEDs 17 are arranged to face the outer side surfaces. The outer side surfaces are the light entrance surfaces 19b. With such a configuration, each of the adjacent areas A that are arranged along the LED housing groove portion 22A receives light from the LEDs 17 facing the light entrance surface 19b that is the inner surface of the LED housing groove portion 22A and also receives light from the LEDs 17 facing the light entrance surface 19b that is the outer side surface of the light guide member 19 that is parallel with the LED housing groove portion 22A. This further improves uniformity of brightness in the light exiting from the light exit surface 19a.

The groove portions 22 have openings on the outer side surfaces of the light guide member 19 and on the surface 19c of the light guide member 19 that is opposite to the light exit surface 19a. With such a configuration, the groove portions 22 have openings not only on the surface 19c of the light guide member 19 that is opposite to the light exit surface 19a but also on the outer side surfaces of the light guide member 19. Accordingly, air inside the groove portions 22 easily flows outside. Therefore, heat generated from the LEDs 17 housed in the LED housing groove portion 22A can be effectively dissipated outside.

The reflection sheet 23 is provided on the surface of the light guide member 19 that is opposite to the light exit surface 19a. With such a configuration, the reflection sheet 23 reflects light that enters the light entrance surface 19b. Therefore, light effectively travels within light guide member 19.

The light source is the LED 17. This achieves improved brightness and low power consumption.

### Second Embodiment

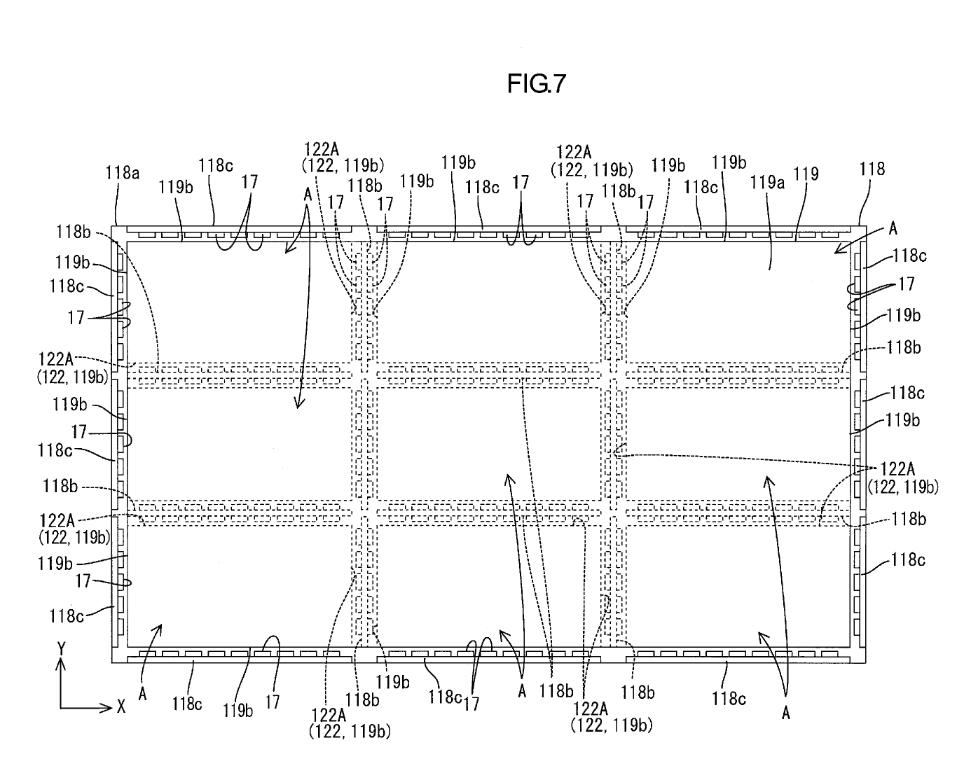

A second embodiment of the present invention will be explained with reference to FIG. 7. In the second embodiment, the number of installed mount boards 118b and 118c and the like is changed. The construction, operations and effects as same as the first embodiment will not explained.

In the present embodiment, the number of installed mount boards 118b and 118c of an LED board 118 is greater than that in the first embodiment. The number of LED housing groove portions 122A that house the mount boards 118b and the LEDs 17 therein is also increased. Specifically, as illustrated in FIG. 7, three single-side mount boards 118c are arranged on each of long-side ends and short-side ends of a base board 118a. Three double-side mount boards 118b are arranged at two positions so as to divide the long side of the base board 118 into three equal parts. Three-double side mount boards 118b are arranged at two positions so as to divide the short side of the base board 118 into three equal parts. The present embodiment is different from the first embodiment in that the mount boards 118b and 118c having main plate surfaces parallel to the X-axis are added. Nine LEDs 17 are arranged linearly in series on a surface of each of the added mount boards 118b and 118c. With such an arrangement of the mount boards 118b and 118c, the LEDs 17 are arranged uniformly in a distributed manner in a wide area in a plan view.

Groove portions 122 that define a light guide member 119 in rows and columns are all the LED housing groove portions 122A that each houses the double-side mount board 118b with the LEDs 17 therein. The LEDs 17 are arranged on the mount boards 118b and 118c so as to surround all sides of each area A. In other words, the LEDs 17 sandwich each area A that is defined by the groove portions 122 in the X-axis direction and the Y-axis direction. Each area A is surrounded by the LEDs 17. The outer peripheral side surfaces of each area A are the light entrance surfaces 119b. In the present embodiment, light enters all sides of each area A. Therefore, exiting light from the light exit surface 119a has improved uniform brightness. Furthermore, the number of LEDs 17 arranged in association with each area A is greater than that in the first embodiment. Accordingly, the amount of light that exits from each area A is relatively increased, thereby improving brightness.

As described above, according to the present embodiment, at least a pair of the groove portions 122 that crosses each other is the LED housing groove portions 122A. With such a configuration, at least the pair of groove portions 122 crossing each other is both the LED housing groove portions 122A. Therefore, the LEDs 17 are arranged in a wider area in a surface area of the light exit surface 119a in a distributed manner. This further improves exiting light in uniformity of brightness.

The groove portions 122 are all the LED housing groove portions 122A. With such a configuration, the LEDs 17 are arranged in a distributed manner in a wider area in the light exit surface 119a. This further improves exiting light in uniformity of brightness.

The LEDs 17 are arranged so as to face all the outer peripheral side surfaces of the light guide member 119. The outer peripheral side surfaces are the light entrance surfaces 119b. With such a configuration, each of the areas A that are provided along the LED housing groove portion 122A receives light from the light entrance surface 119b that is the inner surface of the LED housing groove portion 122A and also receives light from the light entrance surface 119b that is the outer peripheral side surface of the light guide member 119. This further improves exiting light in uniformity of brightness.

### Third Embodiment

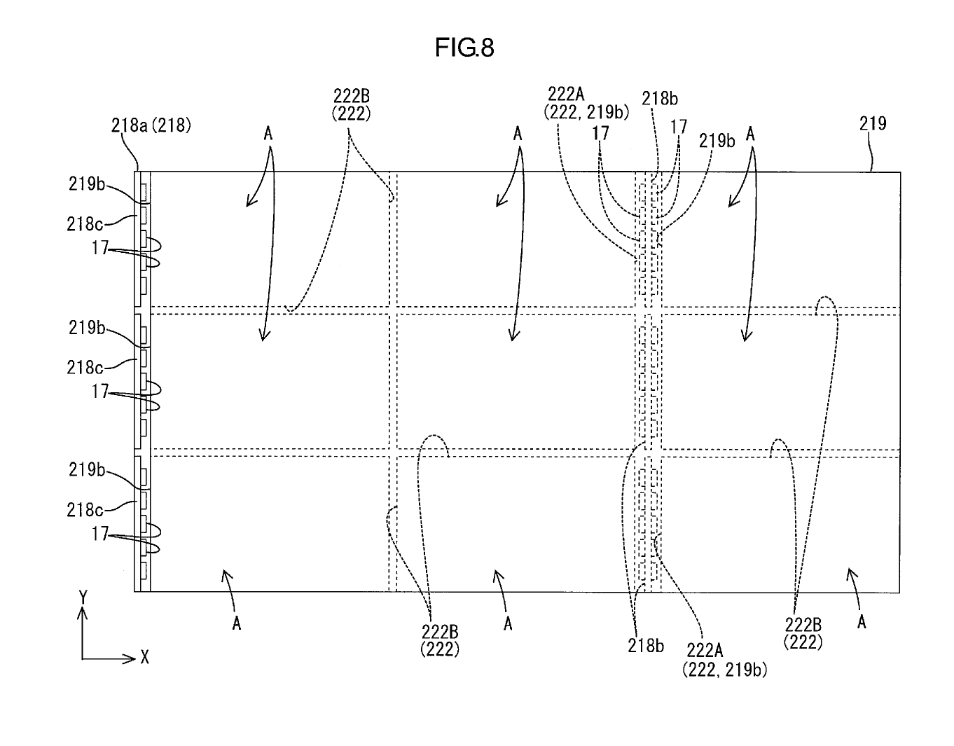

A third embodiment of the present invention will be explained with reference to FIG. 8. In the third embodiment, the number of mount boards 218b and 218b and the like is changed. The construction, operations and effects as same as the first embodiment will not be explained.

In the present embodiment, the number of installed mount boards 218b and 218c in the LED board 118 is smaller than that in the first embodiment. Accordingly, the number of installed defining groove portions 222B is increased and the number of installed LED housing groove portions 222A is decreased. Specifically, as illustrated in FIG. 8, three single-side mount boards 218c are arranged on one end of a long side of a base board 218a. Three double-side mount boards 218b are arranged at a position so as to be away from another end of the long side of the base board 218a inwardly by substantially one third of a long-side dimension of alight guide member 219. In the present embodiment, the number of mount boards 218b and 218c is reduced to be a half of the number of the mount boards in the first embodiment.

Groove portions 222 that define the light guide member 219 in rows and columns include the LED housing groove portions 222A and the defining groove portions 222B. The groove portions 222 that overlap the double-side mount boards 218b in a plan view are the LED housing groove portions 222A. The rest of the groove portions 222 are all the defining groove portions 222B. Among the areas A defined in rows and columns by the groove portion 222, each of three areas A provided on a left end portion in FIG. 8 receives light from the LEDs 17 mounted on the single-side mount board 218c. Each of three areas A provided in a middle portion in FIG. 8 receives light from the LEDs 17 that are mounted on the main plate surface of the double-side mount board 218b on a left side in FIG. 8. Each of three areas A provided in a right end portion in FIG. 8 receives light from the LEDs 17 that are mounted on the main plate surface of the double-side mount board 218b on a right side in FIG. 8. Accordingly, only one outer peripheral side surface of each area A is the light entrance surface 119b that faces the LEDs 17. With such a configuration, the number of installed mount boards 218b and 218c and the number of installed LEDs 17 are reduced. This lowers cost.

### Fourth Embodiment

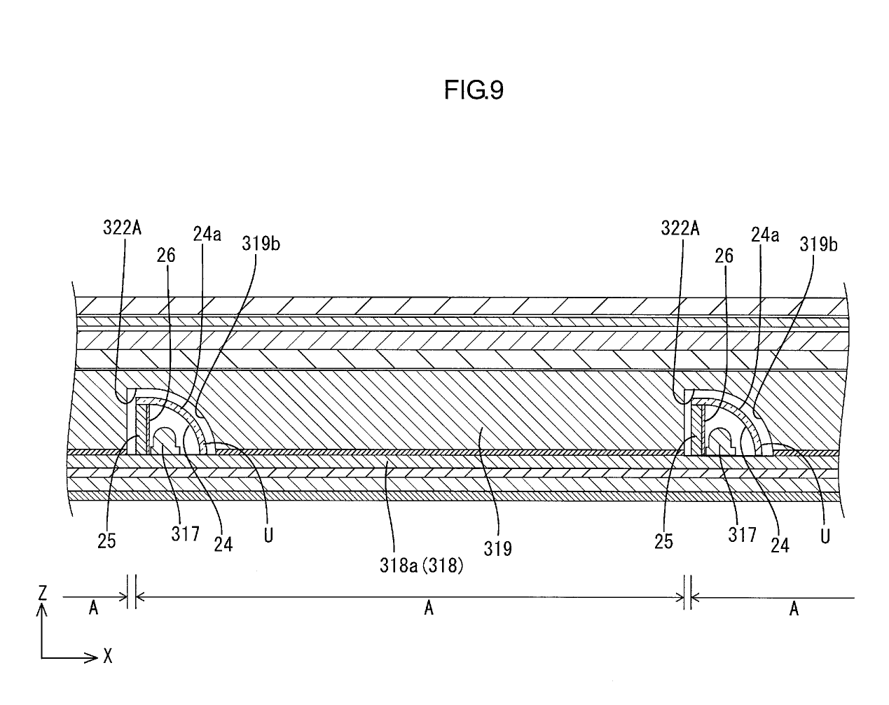

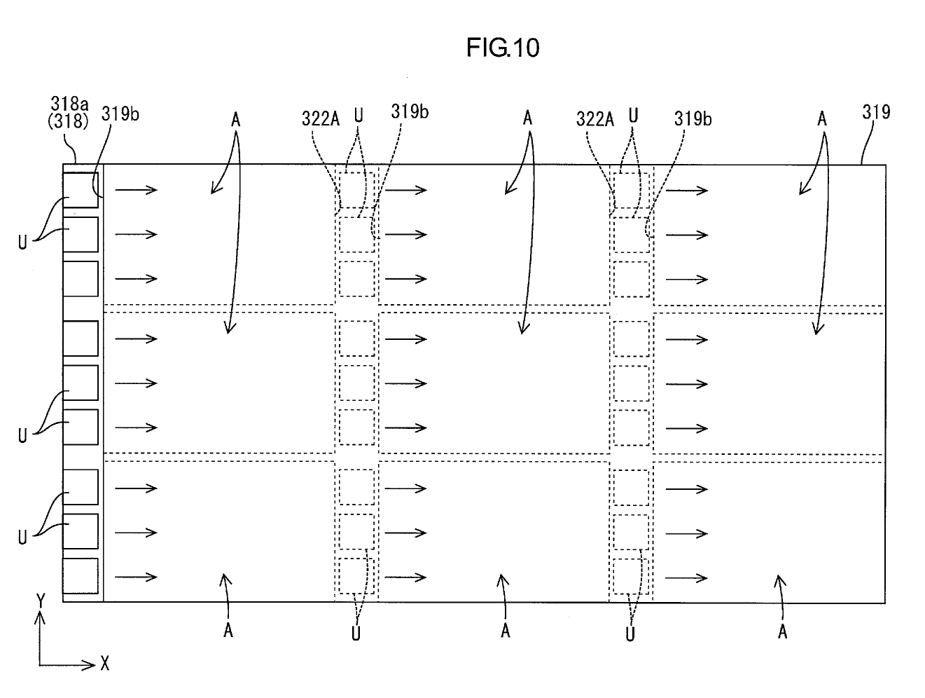

A fourth embodiment of the present invention will be explained with reference to FIGS. 9 and 10. In the third embodiment, an LED board 318 is changed. The construction, operations and effects as same as the first embodiment will not be explained.

According to the present embodiment, the LED board 318 does not include the mount boards of the first to third embodiments and LEDs 317 are directly mounted on a base board 318a. A diffuser lens 24 is also mounted on the base board 318a. The diffuser lens 24 is configured to diffuse light from the LED 317. Specifically, as illustrated in FIG. 9, the LED 317 is directly mounted on the base board 318. Moreover, the diffuser lens 24 is provided on the base board 318a between the LED 317 and a light entrance surface 319b. The diffuser lens 24 is provided so as to cover the LED 317 from the area A on the right side in FIG. 9 among the adjacent areas A that are provided to sandwich an LED housing groove portion 322A. The diffuser lens 24 is formed in substantially an arc in a cross sectional view. As illustrated in FIGS. 9 and 10, a light exit surface 24a of the diffuser lens 24 is directed to one of the adjacent areas A that are provided to sandwich the LED housing groove portion 322A. Accordingly, light emitted from the LED 317 is diffused with being directed to the area A on the right side in FIG. 9 and enters the area A, and therefore the light travels in a wide area within the area A. The directions in which the light is directed by the diffuser lenses 24 are illustrated by arrows in FIG. 10. The LED housing groove portion 322A is formed in a shape so as to follow the outer shape of the diffuser lens 24. The light entrance surface 319b is formed in substantially an arc.

A supporting member 25 and a reflection member 26 are provided on a portion of the base board 318a that is on an immediate left side of the LED 317 in FIG. 9 that is on a opposite side from diffuser lens 24 with respect to the LED 317. The supporting member 25 supports an edge of the diffuser lens 24. The reflection member 26 covers the surface of the support member 25 on the LED 317 side. The reflection member 26 is made of a synthetic resin, and has a surface having white color that provides excellent light reflectivity. The reflection member 26 is configured to effectively reflect light from the LED 317 toward the diffuser lens 24. This allows light from the LED 317 to exit toward the one area A effectively. A light source unit U includes the LED 317, the diffuser lens 24, the supporting member 25 and the reflection member 26. As illustrated in FIG. 10, the light source unit U is arranged on an immediate left side of each area A and a plurality of light source units are arranged in the Y-axis direction.

According to the present embodiment, the diffuser lens 24 is provided between the LED 317 and the light entrance surface 319b and configured to diffuse light from the LED 317. With such a configuration, light from the LED 317 is diffused through the diffuser lens 24 and enters the light entrance surface 319b. Therefore, even if the number of LEDs 317 is small, exiting light from the area A associated with the LEDs 37 is further improved in uniformity of brightness.

The LED board 318 on which the LEDs 317 are mounted is provided. The diffuser lenses 24 are provided on the LED board 318. With such a configuration, the diffuser lenses 24 are provided on the LED board 318 on which the LEDs 317 are mounted. Therefore, the positional relationships between the LEDs 317, the diffuser lenses 24 and the light entrance surface 319b of the light guide member 319 are less likely to vary and uneven brightness is less likely to occur.

The diffuser lens 24 has the light exit surface 24a that directed to one of the adjacent areas A that sandwich the LED housing groove portion 322A. The diffuser lens 24 is provided so as to cover the LED 317 from the one area A side. The reflection member 26 is provided on a side close to another one of the adjacent areas A that sandwich the LED 317 in the LED housing groove portion 322A and configured to reflect light toward the one area A. With such a configuration, light emitted from the LED 317 directly enters the diffuser lens 24 or reflects off the reflection member 26 and enters the diffuser lens 24. The light that enters the diffuser lens 24 exits from the light exit surface 24a toward the one area A. This effectively supplies light to the one area A and improves brightness.

### Fifth Embodiment

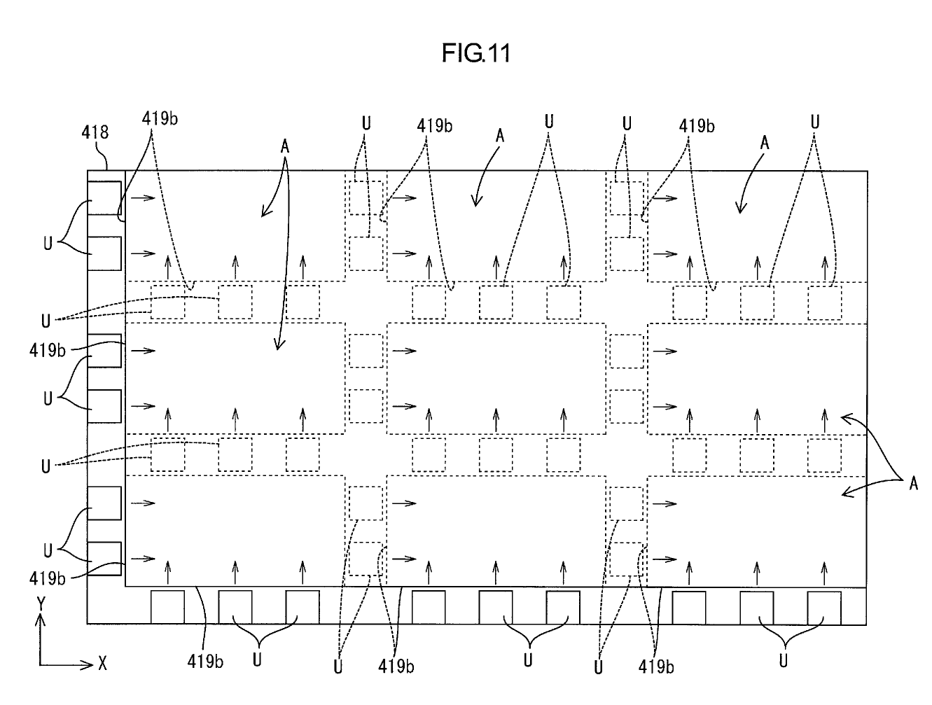

A fifth embodiment of the present invention will be explained with reference to FIG. 11. In the fifth embodiment, the arrangement of the light source units U is changed from the fourth embodiment. The construction, operations and effects as same as the fourth embodiment will not be explained.

The construction of the light source unit U in the present embodiment is the same as that in the fourth embodiment. As illustrated in FIG. 11, a plurality of light source units U is arranged on an LED board 418 in the columns and rows. As illustrated in FIG. 11, the light sources U are arranged on an immediate left side and an immediate lower side of each area in FIG. 11. Light exits in different directions depending on the arrangement of the light sources U. Therefore, adjacent side surfaces (two side surfaces forming an L-shape in a plan view) of the outer peripheral side surfaces of each area A are light entrance surfaces 419b.

### Other Embodiments

As describe above, the embodiments of the present invention have been described. However, the present invention is not limited to the above embodiments described in the above description and the drawings. The following embodiments are also included in the technical scope of the present invention, for example.

(1) The arrangement and the number of mount boards or light source units may be altered if necessary. Accordingly, the arrangement and the number of LED housing groove portions and defining groove portions may be altered. Specifically, in the above embodiments, the mount boards and the light source units are provided so as to face the outer side surfaces of the light guide member. However, the mount boards and the light source units that are arranged as such may not be provided and all the mount boards and all the light source units may be housed in the LED housing groove portions.

(2) In the first to third embodiments, the mount boards housed in the LED housing groove portions are double-side mount boards. However, the single-side mount boards may be housed in the LED housing groove portions.

(3) In the first embodiment, the LED housing groove portion and the mount board housed therein are arranged in the short-side direction of the light guide member. However, the LED housing groove portion and the mount board housed therein may be arranged in the long-side direction of the light guide member. In such a case, the defining groove portion in which no mount board is housed is arranged in the short-side direction of the light guide member.

(4) In the embodiments other than the first to third embodiments, the number of the LEDs mounted on the mount board may be altered if necessary. The number of LEDs mounted on one mount surface of the double-side mount board may differ from the number of LEDs that are mounted on the other mount surface of the double-side mount board.

(5) In the above embodiments, the groove portions are arranged at equal intervals in the light guide member and each area has the same size. However, the groove portions may be arranged at different intervals and the areas may have various sizes.

(6) In the above embodiments, the number of groove portions arranged in the short-side direction of the light guide member and the number of groove portions arranged in the long-side direction of the light guide member are equal (two). However, the number of groove portions arranged in the short-side direction of the light guide member and the number of groove portions arranged in the long-side direction of the light guide member may be different. In such a case, the number of groove portions may be one or three or more.

(7) In the above embodiments, two groove portions are arranged in the short-side direction of the light guide member and two groove portions are arranged in the long-side direction of the light guide member. However, one for each groove portion or three or more for each groove portion may be provided. Furthermore, one of the two kinds of groove portion arranged in the short-side direction of the light guide member and the groove portion arranged in the long-side direction of the light guide member may not be provided.

(8) In the first to third embodiments, the mount boards are arranged along a side of the light guide member so as to be separated from each other. However, for example, the adjacent mount boards may be connected with each other to form a mount board having the substantially same length as a side of the light guide member.

(9) In the first to third embodiments, the LEDs mounted on the mount board are arranged at equal intervals. However, the LEDs mounted on the mount board may be arranged at different intervals.

(10) In the above embodiments, the base board has substantially the same size as the light guide member. However, the base board may be formed smaller in size than the light guide member. In this case, to satisfy the function for electrically connecting each mount board and each light source unit, it is preferable that the base board is formed so as to cover the areas in the light guide member.

(11) In the above embodiments, a plate-shaped base board is used as the “base member.” However, a sheet-shaped flexible wiring board may be used as the “base member.”

(12) In the above embodiments, the number of LEDs that are associated with each area of the light guide member is equal. However, the number of LEDs may vary depending on the area.

(13) In the above embodiments, the groove portion has openings on the rear surface of the light guide member and outer side surface thereof. However, the groove portion may have an opening only on the rear surface of the light guide member and the outer side surface thereof may be closed. With such a configuration, mechanical strength of the light guide member is improved.

(14) In the above embodiments, the LED includes an LED chip emitting light of single color of blue and the LED emits white light by a fluorescent material. The LED may include an LED chip emitting ultraviolet rays and emit white light by a fluorescent material.

(15) In the above embodiments, the LED includes an LED chip emitting light of single color of blue and emits white light by a fluorescent material. However, the LED may include three different kinds of LED chips each of which emits a single color of light of red (R), green (G) or blue (B). The LED may include three different kinds of LED chips each of which emits a single color of light of C (cyan), M (magenta) or Y (yellow).

(16) In the above embodiments, the LEDs that emit white light are used. LEDs that emit red light, LEDs that emit blue light and LEDs that emit green light may be combined properly to be used.

(17) In the above embodiments, the LEDs are used as a point light source. A point-like light source other than the LED may be used.

(18) In the above embodiments, the LED that is a point light source is used as the light source. The point light source is not necessarily used as the light source but a linear light source such as a cold cathode tube or a hot cathode tube may be used as the light source. In using the linear light source, an LED board is not provided and a base portion of the support member is provided directly on the base plate of the chassis.

(19) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(20) In the above embodiments, the liquid crystal display device including the liquid crystal panel as a display panel. The technology can be applied to display devices including other types of display components.

(21) In the above embodiments, the television receiver including the tuner is used. However, the technology can be applied to a display device without a tuner.

### EXPLANATION OF SYMBOLS

10: liquid crystal display device (display device), 11: liquid crystal panel (display panel), 12: backlight unit (lighting device), 17: LED (light source), 17a: light emitting surface, 18: LED board (light source board), 18a: base board (base member), 18b, 18c: mount board, 19: light guide member, 19a: light exit surface, 19b: light entrance surface, 19c: surface (surface that is opposite to the light exit surface), 22: groove portion, 22A: LED housing groove portion, 23: reflection sheet (reflection portion), 24: diffuser lens, 24a: light exit surface, 26: reflection member, A: area, TV: television receiver

1. A lighting device comprising:
a plurality of light sources;
a light guide member having a light entrance surface which light from the plurality of light sources enters and a light exit surface from which light exits; and
a groove portion formed on a surface of the light guide member opposite to the light exit surface so as to divide the light exit surface into a plurality of areas in a plan view, wherein:
the light sources are arranged corresponding to each of the areas; and
the groove portion includes a light source housing groove portion housing at least one of the light sources therein and having an inner surface that is the light entrance surface.

2. The lighting device according to claim 1, wherein:
each of the light sources has a light emitting surface; and
at least a pair of the light sources is arranged in the light source housing groove portion such that the light emitting surfaces of the pair of light sources face in opposite directions; and
the light source housing groove portion has a pair of inner surfaces that faces the pair of light sources and each of the inner surfaces is the light entrance surface.

3. The lighting device according to claim 1, wherein at least a pair of the light sources is arranged so as to sandwich each of the areas.

4. The lighting device according to claim 1, further comprising a light source board on which the light sources are mounted.

5. The lighting device according to claim 4, wherein:
the light source board includes a base member and a mount board;
the base member extends along a surface of the light guide member that is opposite to the light exit surface; and
the mount board is provided to protrude from the base member toward an inner side of the light source housing groove portion.

6. The lighting device according to claim 5, wherein:
the mount board has a pair of surfaces that face in opposite directions, and the light sources are mounted on each of the pair of surfaces; and
the light source housing groove portion has a pair of inner surfaces and each of the inner surfaces is the light entrance surface.

7. The lighting device according to claim 5, wherein the mount board includes a plurality of mount boards and the mount boards are arranged to be away from each other, and each of the mount boards corresponds to each of the areas of the light guide member that are defined by the groove portion.

8. The lighting device according to claim 5, wherein:
the light sources are mounted on the mount board; and
the light sources are connected to each other in series.

9. The lighting device according to claim 8, wherein the light sources are arranged substantially at equal intervals on the mount board.

10. The lighting device according to claim 5, wherein the base member has a size so as to cover the plurality of areas of the light guide member.

11. The lighting device according to claim 10, wherein the base member has substantially a same size as an entire surface area of the light guide member that is opposite to the light exit surface.

12. The lighting device according to claim 1, wherein:
the groove portion includes a plurality of groove portions;
at least a pair of the groove portions is formed so as to cross each other; and
the light guide member is defined by the pair of groove portions such that the plurality of areas is arranged in a row direction and a column direction in a plan view.

13. The lighting device according to claim 12, wherein the plurality of groove portions include the groove portions extending in the row direction and the groove portions extending in the column direction.

14. The lighting device according to claim 12, wherein the plurality of groove portions is arranged such that each of the areas substantially has a same size.

15. The lighting device according to claim 14, wherein a same number of the light sources is provided for each of the areas.

16. The lighting device according to claim 12, wherein one of the pair of the groove portions crossing each other is the light source housing groove portion.

17. The lighting device according to claim 16, wherein:
the light guide member has an outer side surface that is provided in parallel with the light source housing groove portion and the outer side surface faces the light sources; and
the outer side surface of the light guide member is the light entrance surface.

18. The lighting device according to claim 12, wherein:
the light source housing groove portion includes a plurality of light source housing groove portions; and
at least the pair of groove portions crossing each other is the light source housing groove portions.

19. The lighting device according to claim 18, wherein all the groove portions are the light source housing groove portions.

20. The lighting device according to claim 18, wherein:
the light guide member has an outer peripheral side surface and substantially all the outer peripheral side surface faces the plurality of light sources; and
the outer peripheral side surface is the light entrance surface.

21. The lighting device according to claim 1, wherein the groove portion has an opening on the outer side surface of the light guide member and the surface of the light guide member that is opposite to the light exit surface.

22. The lighting device according to claim 1, further comprising a diffuser lens provided between the light sources and the light entrance surface and configured to diffuse light from the light sources.

23. The lighting device according to claim 22, wherein:
the light sources are mounted on the light source board; and
the diffuser lens is provided on the light source board.

24. The lighting device according to claim 22, further comprising a reflection member, wherein:
the diffuser lens has the light exit surface directed to one of the areas that are adjacent to each other so as to sandwich the light source housing groove portion and is arranged so as to cover the light sources from the one of the areas; and
the reflection member is arranged close to another one of the areas with respect to the light source and the areas are adjacent to each other so as to sandwich the light source housing groove portion, and the reflection member is configured to reflect light toward the one of the areas.

25. The lighting device according to claim 1, further comprising a reflection portion provided on a surface of the light guide member that is opposite to the light exit surface and configured to reflect light.

26. The lighting device according to claim 1, the plurality of light sources is LEDs.

27. A display device comprising:
the lighting device according to claim 1; and
a display panel configured to provide display using light from the lighting device.

28. The display device according to claim 27, wherein the display panel is a liquid crystal panel using liquid crystals filled between base boards.

29. A television receiver comprising the display device according to claim 27.
